(19) United States
(12) Patent Application Publication
(10) Pub. No.: US 2022/0339975 A1
(43) Pub. Date: Oct. 27, 2022

(54) TIRE

(71) Applicant: Sumitomo Rubber Industries, Ltd., Kobe-shi (JP)

(72) Inventor: Hiroyuki NAKAYAMA, Kobe-shi (JP)

(73) Assignee: Sumitomo Rubber Industries, Ltd., Kobe-shi (JP)

(21) Appl. No.: 17/725,585

(22) Filed: Apr. 21, 2022

(30) Foreign Application Priority Data
Apr. 22, 2021 (JP) 2021-072330

(51) Int. Cl. B60C 15/06; B60C 11/00; B60C 11/04; B60C 11/12

(52) U.S. Cl. CPC B60C 15/0603; B60C 11/0083; B60C 11/04; B60C 11/1281; B60C 2015/061; B60C 2011/0365

(57) ABSTRACT

A tire can include a tread, sidewalls, beads, and a carcass. Each bead can include a core and an apex. A ratio of a height of the apex to a cross-sectional height of the tire may be not less than 5% and not greater than 15%. In a meridian cross-section of the tire in a standard state, a contour of a side surface including a maximum width position can include two arcs tangent to each other at the maximum width position. The arc located inward of the maximum width position in a radial direction can be a first arc, and the arc located outward of the maximum width position in the radial direction can be a second arc. A ratio of a first radius of the first arc to a second radius of the second arc may be not less than 70% and not greater than 91%.

### CROSS REFERENCE TO RELATED APPLICATION(S)

The present application claims priority to Japanese patent application JP 2021-072330, filed on Apr. 22, 2021, the entire contents of which is incorporated herein by reference in its entirety.

### BACKGROUND

### Technical Field

The present disclosure relates to a tire.

### Background Art

For example, in Japanese Laid-Open Patent Publication No. 2017-121899, the performance of a tire such as durability, rolling resistance, and ride comfort is described as being controlled by adjusting a contour from each shoulder portion of a tread to each sidewall, that is, the contour of each side surface. In order to control the performance of a tire, the contour of the tire may be adjusted in addition to the physical properties, arrangement, etc., of the components included in the tire.

Tires having low rolling resistance may be required in consideration of influence on the environment. When a rubber that has low-heat generation properties is used for a tread, the rolling resistance of a tire may be reduced. When a rubber that has low-heat generation properties is used for the tread, the coefficient of friction of the tire may be decreased. In this case, the braking performance may be decreased. If the coefficient of friction of the tire is increased in order to improve the braking performance, the rolling resistance can increase.

### SUMMARY

A tire according to an aspect of the present disclosure can include: a tread to come into contact with a road surface; a pair of sidewalls each connected to an end of the tread and located inward of the tread in a radial direction; a pair of beads each located inward of a corresponding one of the sidewalls in the radial direction; and a carcass located inward of the tread and the pair of sidewalls. Each bead can include a core and an apex located outward of the core in the radial direction. A ratio of a height of the apex to a cross-sectional height of the tire may be not less than 5% and not greater than 15%. In a meridian cross-section in a state where the tire is fitted on a normal rim, an internal pressure of the tire is adjusted to 250 kPa, and no load is applied to the tire, a contour of each side surface including a maximum width position can include two arcs tangent to each other at the maximum width position, of the two arcs, the arc located inward of the maximum width position in the radial direction can be a first arc, and the arc located outward of the maximum width position in the radial direction can be a second arc. A ratio of a first radius of the first arc to a second radius of the second arc may be not less than 70% and not greater than 91%.

### BRIEF DESCRIPTION OF THE DRAWINGS

FIG. 1 is a cross-sectional view showing a part of a tire according to an embodiment of the present disclosure;

FIG. 2 is a cross-sectional view showing a bead portion of the tire of FIG. 1;

FIG. 3 is a development showing the outer surface of a tread;

FIG. 4 is a cross-sectional view showing a part of the tread;

FIG. 5 is a cross-sectional view taken along a line a-a in FIG. 3; and

FIG. 6 is a cross-sectional view taken along a line b-b in FIG. 3.

### DETAILED DESCRIPTION

Hereinafter, the present disclosure will be described in detail based on preferred embodiments with appropriate reference to the drawings.

The present disclosure has been made in view of the above-described circumstances, and an object of the present disclosure, among one or more objects, can be to provide a tire that can achieve improvement of braking performance without a significant increase in rolling resistance.

In the present disclosure, a state where a tire is fitted on a normal rim, the internal pressure of the tire is adjusted to a normal internal pressure, and no load is applied to the tire can be referred to or characterized as a normal state. A state where a tire is fitted on a normal rim, the internal pressure of the tire is adjusted to 250 kPa, and no load is applied to the tire can be referred to or characterized as a standard state.

In the present disclosure, unless otherwise specified, the dimensions and angles of each component of the tire are measured in the standard state. The dimensions and angles of each component in a meridian cross-section of the tire, which cannot be measured in a state where the tire is fitted on the normal rim, can be measured in a cross-section of the tire obtained by cutting the tire along a plane including a rotation axis, with the distance between left and right beads being made equal to the distance between the beads in the tire that is fitted on the normal rim.

The normal rim can mean a rim specified in a standard on which the tire is based. The “standard rim” in the JATMA standard, the “Design Rim” in the TRA standard, and the “Measuring Rim” in the ETRTO standard can be normal rims.

The normal internal pressure can mean an internal pressure specified in the standard on which the tire is based. The “highest air pressure” in the JATMA standard, the “maximum value” recited in “TIRE LOAD LIMITS AT VARIOUS COLD INFLATION PRESSURES” in the TRA standard, and the “INFLATION PRESSURE” in the ETRTO standard can be normal internal pressures.

The normal load can mean a load specified in the standard on which the tire is based. The “maximum load capacity” in the JATMA standard, the “maximum value” recited in the “TIRE LOAD LIMITS AT VARIOUS COLD INFLATION PRESSURES” in the TRA standard, and the “LOAD CAPACITY” in the ETRTO standard can be normal loads.

In the present disclosure, a tread portion of the tire can be a portion of the tire that comes into contact with a road surface. A bead portion can be a portion of the tire that is fitted to a rim. A side portion can be a portion of the tire that extends between the tread portion and the bead portion. The tire can include a tread portion, a pair of bead portions, and a pair of side portions as portions thereof.

The rim can include a seat and a flange. When the tire is fitted to the rim, the inner peripheral surface of the bead portion can be placed on the seat, and the outer surface of the bead portion can come into contact with the flange.

In the present disclosure, a loss tangent (also referred to as tans), at a temperature of 30° C., of a component formed from a crosslinked rubber, of the components included in the tire, can be measured using a viscoelasticity spectrometer (e.g., “VES” manufactured by Iwamoto Seisakusho) under the following conditions according to the standards of JIS K6394.
Initial strain=10%
Dynamic strain=2%
Frequency=10 Hz
Deformation mode=tension

In this measurement, a test piece can be sampled from the tire. When a test piece cannot be sampled from the tire, a test piece can be sampled from a sheet-shaped crosslinked rubber (hereinafter, also referred to as a rubber sheet) obtained by pressurizing and heating a rubber composition, which can be used for forming the component to be measured, at a temperature of 170° C. for 12 minutes, for instance.

In the present disclosure, the hardness of a component formed from a crosslinked rubber, of the components included in the tire, can be measured according to the standards of JIS K6253 under a temperature condition of 23° C. using a type A durometer, for instance. If the hardness cannot be measured in the tire, a test piece formed from a crosslinked rubber obtained by pressurizing and heating a rubber composition, which can be used for forming the component to be measured, at a temperature of 170° C. for 12 minutes, for instance, can be used.

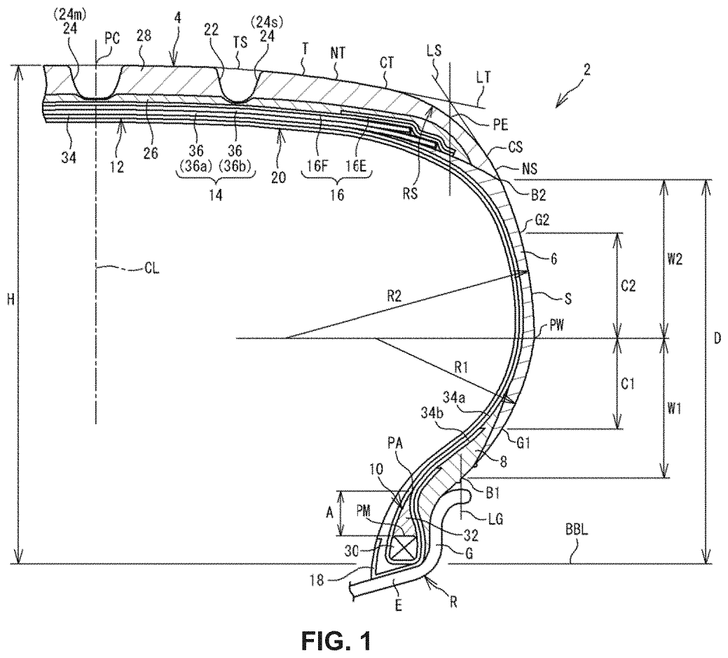

FIG. 1 shows a part of a tire 2 according to an embodiment of the present disclosure. The tire 2 can be a tire for a passenger car. In FIG. 1, the tire 2 is fitted on a rim R. The rim R can be a normal rim. The interior of the tire 2 can be filled with air to adjust the internal pressure of the tire 2. The tire 2 shown in FIG. 1 is in the standard state.

The tire 2 fitted on the rim R may be also referred to as a tire-rim assembly. The tire-rim assembly can include the rim R and the tire 2 fitted on the rim R.

FIG. 1 shows a part of a cross-section (hereinafter, also referred to as a meridian cross-section) of the tire 2 taken along a plane including the rotation axis of the tire 2. In FIG. 1, the right-left direction is the axial direction of the tire 2, and the up-down direction is the radial direction of the tire 2. The direction perpendicular to the surface of the drawing sheet of FIG. 1 is the circumferential direction of the tire 2. In FIG. 1, an alternate long and short dash line CL can represent the equator plane of the tire 2.

In FIG. 1, a solid line BBL extending in the axial direction can represent a bead base line. The bead base line BBL can be a line that defines the rim diameter (see JATMA or the like) of the rim R.

In FIG. 1, a position indicated by reference character PW can be an outer end in the axial direction of the tire 2. In the case where decorations such as patterns and letters are present on the outer surface of the tire 2, the outer end PW can be specified based on a virtual outer surface obtained on the assumption that the decorations are not present. The distance in the axial direction from one outer end PW to the other outer end PW can be the maximum width of the tire 2, that is, the cross-sectional width (see JATMA or the like) of the tire 2. Each outer end PW can be a position (hereinafter, referred to as a maximum width position) at which the tire 2 has the maximum width. The maximum width position PW can be specified in the tire 2 in the standard state.

The tire 2 can include a tread 4, a pair of sidewalls 6, a pair of clinches 8, a pair of beads 10, a carcass 12, a belt 14, a band 16, a pair of chafers 18, and an inner liner 20.

The tread 4 can come into contact with a road surface at the outer surface thereof. Grooves 22 can be formed on the tread 4. Accordingly, a tread pattern can be formed.

The grooves 22 forming the tread pattern of the tire 2 can include circumferential grooves 24, which may continuously extend in the circumferential direction. In the tire 2, a plurality of circumferential grooves 24 can be formed on the tread 4 so as to be aligned in the axial direction. In the tire 2 shown in FIG. 1, three circumferential grooves 24 can be formed on the tread 4, as an example. Among the three circumferential grooves 24, the circumferential groove 24 located on each outer side in the axial direction can be a shoulder circumferential groove 24s. The circumferential groove 24 located inward of the shoulder circumferential groove 24s in the axial direction can be a middle circumferential groove 24m. In the tire 2, the middle circumferential groove 24m can be located on the equator plane CL.

In the tire 2, the arrangement, the groove depths, and the groove widths of the circumferential grooves 24 formed on the tread 4 are not particularly limited. As the arrangement, the groove depths, and the groove widths of the circumferential grooves 24 of the tire 2, a typical arrangement, groove depth, and groove width can be applied to the tread 4.

In FIG. 1, a position indicated by reference character PC can correspond to the equator of the tire 2. The equator PC can be the point of intersection of the outer surface of the tread 4 and the equator plane CL. In the tire 2, since the middle circumferential groove 24m can be located on the equator plane CL, the equator PC can be specified based on a virtual outer surface obtained on the assumption that the middle circumferential groove 24m is not provided.

In FIG. 1, a length indicated by reference character H can be the cross-sectional height (see JATMA or the like) of the tire 2. The cross-sectional height H can be the distance in the radial direction from the bead base line BBL to the equator PC. The cross-sectional height H can be measured in the tire 2 in the standard state.

The tread 4 can have a base layer 26 and a cap layer 28. The base layer 26 can cover the belt 14 and the band 16. The base layer 26 can be formed from a crosslinked rubber that has low-heat generation properties. In the tire 2, the loss tangent at 30° C. of the base layer 26 may be not greater than 0.11.

The cap layer 28 can be located outward of the base layer 26 in the radial direction. The cap layer 28 can cover the entirety of the base layer 26. The outer surface of the cap layer 28 can be the outer surface of the tread 4. The cap layer 28 can be formed from a crosslinked rubber for which wear resistance and grip performance are taken into consideration. The loss tangent of the cap layer 28 can be larger than that of the base layer 26. From the viewpoint that the cap layer 28 can contribute to reduction of rolling resistance, the loss tangent of the cap layer 28 can be preferably not greater than 0.30 and more preferably not greater than 0.20.

Each sidewall 6 can be connected to an end of the tread 4. The sidewall 6 can be located inward of the tread 4 in the radial direction. The sidewall 6 can extend from the end of the tread 4 toward the clinch 8 along the carcass 12. The sidewall 6 can be formed from a crosslinked rubber for which cut resistance is taken into consideration.

Each clinch 8 can be located inward of the sidewall 6 in the radial direction. The clinch 8 can come into contact with a flange G of the rim R. The clinch 8 can be formed from a crosslinked rubber for which abrasion resistance is taken into consideration.

Each bead 10 can be located inward of the clinch 8 in the axial direction. The bead 10 can be located inward of the sidewall 6 in the radial direction. The bead 10 can include a core 30 and an apex 32. The core 30 can include a wire made of steel, for instance.

The apex 32 can be located outward of the core 30 in the radial direction. The apex 32 can be tapered outward. The apex 32 can be formed from a crosslinked rubber that has high stiffness. The hardness of the apex 32 may be not less than 80 and not greater than 98. In FIG. 1, a position indicated by reference character PA can be the outer end in the radial direction (hereinafter, also referred to as a tip) of the apex 32.

The carcass 12 can be located inward of the tread 4, the pair of sidewalls 6, and the pair of clinches 8. The carcass 12 can extend on and between one bead 10 and the other bead 10. The carcass 12 can have a radial structure.

The carcass 12 can include at least one carcass ply 34. From the viewpoint of reduction of rolling resistance, the carcass 12 can be preferably composed of one carcass ply 34.

The carcass 12 of the tire 2 can be composed of one carcass ply 34. The carcass ply 34 can include a ply body 34a which can extend between one bead 10 and the other bead 10, and a pair of turned-up portions 34b which can be connected to the ply body 34a and turned up around the respective beads 10 from the inner side toward the outer side in the axial direction. In the radial direction, the end of each turned-up portion 34b can be located inward of the maximum width position PW. The end of the turned-up portion 34b can be located between the ply body 34a and the sidewall 6. In a zone from the tip PA of the apex 32 to the end of the turned-up portion 34b, the turned-up portion 34b can be joined to the ply body 34a.

Each carcass ply 34 can include a large number of carcass cords aligned with each other. Each carcass cord can intersect the equator plane CL. The carcass cords can be cords formed from an organic fiber. Examples of the organic fiber include nylon fibers, rayon fibers, polyester fibers, and aramid fibers.

The belt 14 can be located inward of the tread 4 in the radial direction. The belt 14 can be stacked on the carcass 12 from the outer side in the radial direction. In the tire 2, the width in the axial direction of the belt 14 may be not less than 65% and not greater than 85% of the cross-sectional width.

The belt 14 can include at least two layers 36 stacked in the radial direction. The belt 14 of the tire 2 can be composed of two layers 36 stacked in the radial direction. Of the two layers 36, the layer 36 located on the inner side can be an inner layer 36a, and the layer 36 located on the outer side can be an outer layer 36b. As shown in FIG. 1, the inner layer 36a can be wider than the outer layer 36b. The length from the end of the outer layer 36b to the end of the inner layer 36a may be not less than 3 mm and not greater than 10 mm.

Each of the inner layer 36a and the outer layer 36b can include a large number of belt cords aligned with each other. Each belt cord can be inclined relative to the equator plane CL. The material of each belt cord can be steel, for instance.

The band 16 can be located between the tread 4 and the belt 14 in the radial direction. The band 16 can be stacked on the belt 14 on the inner side of the tread 4. The band 16 can cover the entirety of the belt 14. The band 16 can be wider than the belt 14. The length from an end of the belt 14 to an end of the band 16 may be not less than 3 mm and not greater than 7 mm.

The band 16 can include a helically wound band cord. The band cord can extend substantially in the circumferential direction. Specifically, an angle of the band cord with respect to the circumferential direction may be not greater than 5° (including zero). The band 16 can have a jointless structure. In the tire 2, a cord formed from an organic fiber can be used as the band cord. Examples of the organic fiber include nylon fibers, rayon fibers, polyester fibers, and aramid fibers.

The band 16 of the tire 2 can include a full band 16F and a pair of edge bands 16E. The full band 16F can have ends opposing each other across the equator plane CL. Each end of the full band 16F can be located outward of the end of the belt 14 in the axial direction. The full band 16F can be stacked on the belt 14. The full band 16F can cover the entirety of the belt 14 from the outer side in the radial direction. The pair of edge bands 16E can be disposed so as to be spaced apart from each other in the axial direction with the equator plane CL therebetween. Each edge band 16E can be stacked on the full band 16F. The edge band 16E can cover the end of the full band 16F from the outer side in the radial direction. The band 16 may be composed of a full band 16F, or may be composed of a pair of edge bands 16E.

Each chafer 18 can be located radially inward of the bead 10. The chafer 18 can come into contact with a seat E of the rim R. The chafer 18 of the tire 2 can include a fabric and a rubber with which the fabric is impregnated.

The inner liner 20 can be located inward of the carcass 12. The inner liner 20 can form an inner surface of the tire 2. The inner liner 20 can be formed from a crosslinked rubber that has a low gas permeability coefficient. The inner liner 20 can maintain the internal pressure of the tire 2.

The contour of the tire 2 can be obtained, for example, by measuring the outer surface shape of the tire 2 in the standard state by a displacement sensor. In the meridian cross-section, the contour of the outer surface (hereinafter, referred to as a tire outer surface TS) of the tire 2 can be formed by connecting a plurality of contour lines each formed as a straight line or an arc. In the present disclosure, the contour line formed as a straight line or an arc may be referred to simply as a contour line. The contour line formed as a straight line ,may be referred to as a straight contour line, and the contour line formed as an arc may be referred to as a curved contour line.

The tire outer surface TS can include a tread surface T and a pair of side surfaces S connected to the ends of the tread surface T. In the present disclosure, the contour of the tread surface T is described as the contour of a virtual outer surface (also referred to as a virtual tread surface) obtained on the assumption that no grooves are provided thereon. The tread surface T can include the above-described equator PC. The contour of each side surface S is described as the contour of a virtual outer surface (also referred to as a virtual side surface) obtained on the assumption that no decorations such as patterns and characters are provided thereon. Each side surface S can include the above-described maximum width position PW.

In the meridian cross-section, the contour of the tread surface T can include a plurality of curved contour lines having different radii. In the tire 2, among the plurality of curved contour lines included in the contour of the tread surface T, a curved contour line having the smallest radius can be located at the end portion of the tread surface T and can be connected to the side surface S. In the meridian cross-section, the contour of the tire outer surface TS can include, on each end portion of the tread surface T, a curved line portion that can be a curved contour line connected to the side surface S and formed as an arc having the smallest radius among the plurality of curved contour lines included in the contour of the tread surface T. In FIG. 1, the curved line portion is indicated by reference character RS.

In the contour of the tire outer surface TS, the curved line portion RS can be tangent to a contour line (hereinafter, referred to as an inner adjacent contour line NT) adjacent to the curve line portion RS on the inner side in the axial direction, at a contact point CT. The curved line portion RS can be tangent to a contour line (hereinafter, referred to as an outer adjacent contour line NS) that can be adjacent to the curve line portion RS on the outer side in the axial direction and forms a contour of the side surface S, at a contact point CS. The contour of the tire outer surface TS can include the inner adjacent contour line NT which can be located axially inward of the curved line portion RS and can be tangent to the curved line portion RS, and the outer adjacent contour line NS which can be located axially outward of the curved line portion RS and can be tangent to the curved line portion RS.

In FIG. 1, a solid line LT can be a line tangent to the curved line portion RS at the contact point CT between the inner adjacent contour line NT and the curved line portion RS. A solid line LS can be a line tangent to the curved line portion RS at the contact point CS between the outer adjacent contour line NS and the curved line portion RS. A position indicated by reference character PE can be the point of intersection of the tread surface T and a straight line that passes through the point of intersection of the tangent line LT and the tangent line LS and that extends in the radial direction. In the tire 2, the point of intersection PE can be a tread reference end. The contact point CS can correspond to the boundary between the tread surface T and the side surface S.

In FIG. 1, reference character B1 can indicate a specific position on the side surface S. A solid line LG can be a straight line that passes through the outer end in the radial direction of the flange G and that extends in the radial direction. The specific position B1 can be the point of intersection of the straight line LG and the side surface S. The specific position B1 can be a flange reference position.

In FIG. 1, reference character B2 can indicate a specific position on the side surface S. A length indicated by a double-headed arrow D can be the distance in the radial direction from the bead base line BBL to the specific position B2. In the tire 2, the distance D in the radial direction can be set to be 0.77 times the cross-sectional height H. The specific position B2 can be a position, on the side surface S, at which the distance D in the radial direction from the bead base line BBL indicates 0.77 times the cross-sectional height H. The specific position B2 can be a buttress reference position.

As described above, each side surface S can include the maximum width position PW. In the meridian cross-section, the contour of the side surface S can include two curved contour lines, that is, two arcs, which can be tangent to each other at the maximum width position PW. Of the two arcs that can be tangent to each other at the maximum width position PW, the arc located inward of the maximum width position PW in the radial direction can be a first arc, and the arc located outward of the maximum width position PW in the radial direction can be a second arc. The curved contour line composed of the first arc may also be referred to as a first curved contour line, and the curved contour line composed of the second arc may also be referred to as a second curved contour line.

In FIG. 1, an arrow indicated by reference character R1 can indicate the radius of the first arc (i.e., a first radius), and an arrow indicated by reference character R2 can indicate the radius of the second arc (i.e., a second radius). The center of the first arc and the center of the second arc can be located on a straight line that passes through the maximum width position PW and that extends in the axial direction.

In the tire 2, the radius R1 of the first arc can be smaller than the radius R2 of the second arc. Specifically, the ratio (R1/R2) of the radius R1 of the first arc to the radius R2 of the second arc may be not greater than 91%. Accordingly, in the meridian cross-section, the carcass 12 can be disposed further outside. Since the carcass 12 can be formed so as to be longer, the vertical stiffness can be effectively reduced in the tire 2. Since the vertical stiffness can be relatively low, the tire 2 can ensure a wide ground-contact surface during braking in which a relatively large load can be applied. From this viewpoint, the ratio (R1/R2) can be preferably not greater than 90%, more preferably not greater than 88%, and further preferably not greater than 86%.

In the tire 2, the ratio (R1/R2) of the radius R1 of the first arc to the radius R2 of the second arc may be not less than 70%. Accordingly, the contact area between the bead portion and the flange G can be appropriately maintained. The fluctuation of friction and strain caused by repeated deformation and restoration of the bead portion during running can be effectively suppressed, so that good durability is maintained. From this viewpoint, the ratio (R1/R2) can be preferably not less than 75%, more preferably not less than 78%, and further preferably not less than 80%.

In FIG. 1, a position indicated by reference character PM can be the width center in the axial direction of a surface, of the apex 32, which can be in contact with the core 30. A length indicated by reference character A can be the distance in the radial direction from the width center PM to the tip PA of the apex 32. In the tire 2, the distance A in the radial direction can be the height of the apex 32.

In the tire 2, the ratio (A/H) of the height A of the apex 32 to the cross-sectional height H may be not greater than 15%. The ratio (A/H) can be set so as to be not less than about 20%. The height A of the apex 32 can be relatively low. The apex 32 having a relatively low height A can contribute to reduction of vertical stiffness. The apex 32 can also contribute to disposing the carcass 12 further outside in the meridian cross-section. In the tire 2, the vertical stiffness can be effectively reduced. The apex 32 can contribute to ensuring a ground-contact area. The apex 32 can also contribute to reduction of rolling resistance.

In the tire 2, the ratio (A/H) of the height A of the apex 32 to the cross-sectional height H may be not less than 5%. In the tire 2, the apex 32 having the required height A can be formed. The apex 32 can effectively hold the core 30 in the bead portion fitted on the rim R. The movement of the core 30 during running can be suppressed, so that the required durability can be ensured in the tire 2.

In the tire 2, the ratio (R1/R2) of the radius R1 of the first arc to the radius R2 of the second arc may be not greater than 91%, and the ratio (A/H) of the height A of the apex 32 to the cross-sectional height H may be not greater than 15%. In the tire 2, a ground-contact width can increase, and a ground-contact area can increase. The increase in ground-contact area can increase the coefficient of friction of the tire 2. In the tire 2, even when a rubber that has low-heat generation properties is used for the tread 4, good braking performance can be achieved. It may not be necessary to use a rubber that places importance on grip force and that has heat generation properties, for the tread 4 in order to increase the coefficient of friction. In the tire 2, improvement of braking performance can be achieved without a significant increase in rolling resistance.

In the tire 2, the ratio (R1/R2) of the radius R1 of the first arc to the radius R2 of the second arc may be not less than 70%, and the ratio (A/H) of the height A of the apex 32 to the cross-sectional height H may be not less than 5%. In the tire 2, the required durability can be ensured.

In the tire 2, the ratio (R1/R2) of the radius R1 of the first arc to the radius R2 of the second arc may be not less than 70% and not greater than 91%, and the ratio (A/H) of the height A of the apex 32 to the cross-sectional height H may be not less than 5% and not greater than 15%. The tire 2 can achieve improvement of braking performance without a significant increase in rolling resistance and a significant decrease in durability.

In the tire 2, preferably, the radius R1 of the first arc may be not less than 50 mm and not greater than 65 mm. When the radius R1 is set so as to be not less than 50 mm, the contact area between the bead portion and the flange G can be appropriately maintained. The fluctuation of friction and strain caused by repeated deformation and restoration of the bead portion during running can be effectively suppressed, so that good durability can be maintained. From this viewpoint, the radius R1 can be more preferably not less than 53 mm and further preferably not less than 55 mm. When the radius R1 is set so as to be not greater than 65 mm, the carcass 12 can be disposed further outside in the meridian cross-section. Since the carcass 12 can be formed so as to be longer, the vertical stiffness can be effectively reduced in the tire 2. The tire 2 can ensure a wide ground-contact surface during braking in which a large load may be applied. In the tire 2, good braking performance can be achieved. From this viewpoint, the radius R1 can be more preferably not greater than 62 mm and further preferably not greater than 60 mm.

In FIG. 1, a position indicated by reference character G1 can be an end point of the first arc when the maximum width position PW is defined as a start point of the first arc. A length indicated by reference character C1 can be the distance in the radial direction from the maximum width position PW to the end point G1. A length indicated by reference character W1 can be the distance in the radial direction from the maximum width position PW to the flange reference position B1.

In the tire 2, from the viewpoint that a portion, of the side surface S, which is represented by the first arc can effectively contribute to reduction of vertical stiffness, the ratio (C1/W1) of the distance C1 in the radial direction from the maximum width position PW to the end point G1 of the first arc, to the distance W1 in the radial direction from the maximum width position PW to the flange reference position B1, can be preferably not less than 0.70, more preferably not less than 0.80, and further preferably not less than 0.90. The ratio (C1/W1) can be particularly preferably 1.00.

In FIG. 1, a position indicated by reference character G2 can be an end point of the second arc when the maximum width position PW is defined as a start point of the second arc. A length indicated by reference character C2 can be the distance in the radial direction from the maximum width position PW to the end point G2. A length indicated by reference character W2 can be the distance in the radial direction from the maximum width position PW to the buttress reference position B2.

In the tire 2, from the viewpoint that a portion, of the side surface S, which is represented by the second arc can effectively contribute to reduction of vertical stiffness, the ratio (C2/W2) of the distance C2 in the radial direction from the maximum width position PW to the end point G2 of the second arc, to the distance W2 in the radial direction from the maximum width position PW to the buttress reference position B2, can be preferably not less than 0.70, more preferably not less than 0.80, and further preferably not less than 0.90. The ratio (C2/W2) can be particularly preferably 1.00.

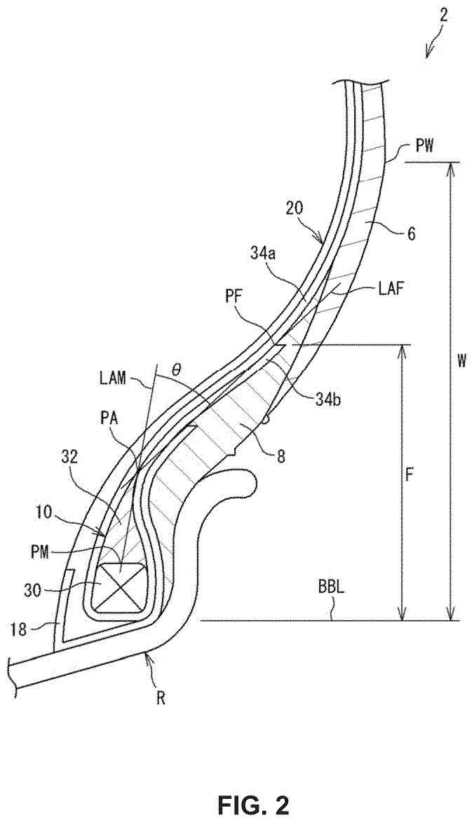

FIG. 2 shows a part of the meridian cross-section shown in FIG. 1. FIG. 2 shows the bead portion of the tire 2. In FIG. 2, the right-left direction is the axial direction of the tire 2, and the up-down direction is the radial direction of the tire 2. The direction perpendicular to the surface of the drawing sheet of FIG. 2 is the circumferential direction of the tire 2.

In FIG. 2, a position indicated by reference character PF can be the end of the turned-up portion 34b. A length indicated by reference character F can be the distance in the radial direction from the bead base line BBL to the end PF of the turned-up portion 34b. The distance F in the radial direction can be the height of the turned-up portion 34b. A length indicated by reference character W can be the distance in the radial direction from the bead base line BBL to the maximum width position PW. The distance W in the radial direction can be a maximum width height.

In the tire 2, the ratio (F/W) of the height F of the turned-up portion 34b to the maximum width height W can be preferably not less than 48% and not greater than 68%.

When the ratio (F/W) is set so as to be not less than 48%, concentration of strain on the end PF of the turned-up portion 34b when a force is applied to the bead portion can be suppressed. In the tire 2, good durability can be achieved. From this viewpoint, the ratio (F/W) can be more preferably not less than 50%. When the ratio (F/W) is set so as to be not greater than 68%, the vertical stiffness can be effectively reduced, so that the tire 2 can ensure a wide ground-contact surface during braking in which a large load may be applied. In the tire 2, good braking performance can be achieved. The low turned-up portion 34b can also contribute to reduction of rolling resistance. From this viewpoint, the ratio (F/W) can be more preferably not greater than 65%.

In FIG. 2, a solid line LAM can be a straight line that passes through the tip PA of the apex 32 and the width center PM. A solid line LAF can be a straight line that passes through the tip PA of the apex 32 and the end PF of the turned-up portion 34b. An angle θ can be an angle formed between the straight line LAM and the straight line LAF.

In the tire 2, when the ratio (F/W) of the height F of the turned-up portion 34b to the maximum width height W is not less than 48% and not greater than 68%, the angle θ formed between the straight line LAM, which can pass through the tip PA of the apex 32 and the width center PM, and the straight line LAF, which can pass through the tip PA of the apex 32 and the end PF of the turned-up portion 34b, can be preferably not less than 35 degrees and not greater than 50 degrees.

When the angle θ is set so as to be not less than 35 degrees, the carcass 12 can be disposed further outside in the meridian cross-section. Since the carcass 12 can be formed so as to be longer, the vertical stiffness can be effectively reduced in the tire 2. From this viewpoint, the angle θ can be more preferably not less than 38 degrees and further preferably not less than 40 degrees. When the angle θ is set so as to be not greater than 50 degrees, the contact area between the bead portion and the flange G can be appropriately maintained. The fluctuation of friction and strain caused by repeated deformation and restoration of the bead portion during running can be effectively suppressed, so that good durability can be maintained. From this viewpoint, the angle θ can be more preferably not greater than 48 degrees and further preferably not greater than 45 degrees.

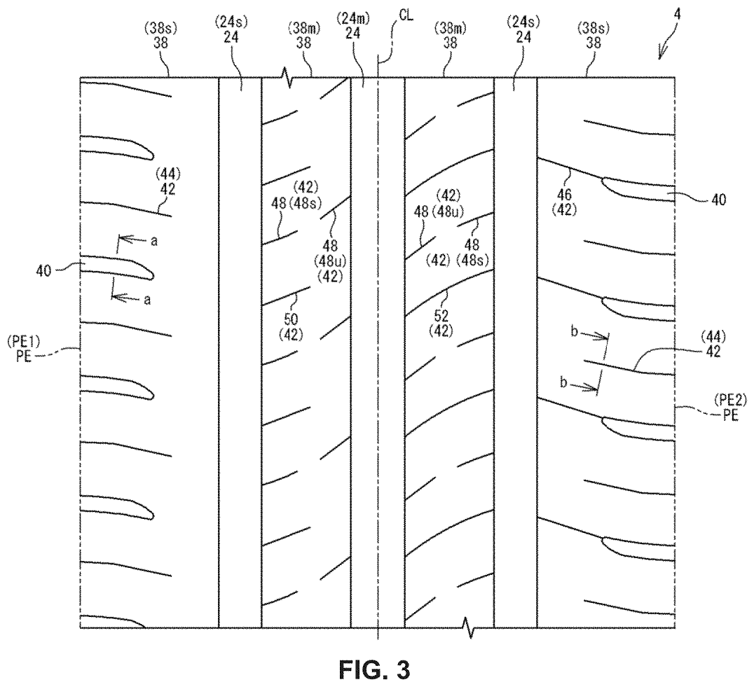

FIG. 3 shows a part of the outer surface of the tread 4. In FIG. 3, the right-left direction is the axial direction of the tire 2, and the up-down direction is the circumferential direction of the tire 2. The direction perpendicular to the surface of the drawing sheet of FIG. 3 is the radial direction of the tire 2. In FIG. 3, the tread reference end PE located on the left side can be a first tread reference end PE1, and the tread reference end PE located on the right side can be a second tread reference end PE2. When the tire 2 is mounted to a vehicle, the first tread reference end PE1 can be located on the outer side in the width direction of the vehicle.

As described above, the grooves 22 can be formed on the tread 4 of the tire 2, and the tread pattern is formed. Among the grooves 22 forming the tread pattern, grooves each having a groove width of 1.5 mm or less can be referred to as sipes.

In the present disclosure, a groove extending substantially in the axial direction can mean that an angle of the groove with respect to the axial direction can be not greater than 45 degrees. A groove extending substantially in the axial direction may also be referred to as a lateral groove. Likewise, a sipe extending substantially in the axial direction may also be referred to as a lateral sipe.

As described above, in the tire 2, the plurality of circumferential grooves 24 can be formed on the tread 4. Accordingly, a plurality of land portions 38 can be formed. In the tire 2, the three circumferential grooves 24 can be formed on the tread 4, so that four land portions 38 can be formed so as to be aligned in the axial direction. Among the four land portions 38, the land portion 38 located on each outer side in the axial direction can be a shoulder land portion 38s. The land portion 38 located inward of the shoulder land portion 38s can be a middle land portion 38m.

A lateral groove 40 can be formed on each shoulder land portion 38s. The lateral groove 40 can have at least a groove width of 2.0 mm or more. The lateral groove 40 can have an end within the shoulder land portion 38s. The lateral groove 40 can extend from this end toward the tread reference end PE. The lateral groove 40 can extend substantially in the axial direction. The direction in which the lateral groove 40 on the shoulder land portion 38s on the first tread reference end PE1 side is inclined can be the same as the direction in which the lateral groove 40 on the shoulder land portion 38s on the second tread reference end PE2 side is inclined. On each shoulder land portion 38s, a plurality of lateral grooves 40 can be formed. These lateral grooves 40 can be arranged at intervals in the circumferential direction.

A dead-end sipe 44 can be formed as a lateral sipe 42 on each shoulder land portion 38s. The dead-end sipe 44 can have an end in the shoulder land portion 38s. The dead-end sipe 44 can extend from this end toward the tread reference end PE. The direction in which the dead-end sipe 44 is inclined can be the same as the direction in which the lateral groove 40 is inclined. On each shoulder land portion 38s, a plurality of dead-end sipes 44 can be formed. In the tire 2, the lateral grooves 40 and the dead-end sipes 44 can be arranged alternately in the circumferential direction.

A connection sipe 46 can be formed as a lateral sipe 42 on the shoulder land portion 38s on the second tread reference end PE2 side. The connection sipe 46 can extend between the shoulder circumferential groove 24s and the lateral groove 40. The direction in which the connection sipe 46 is inclined can be the same as the direction in which the lateral groove 40 is inclined. On each shoulder land portion 38s, connection sipes 46, the number of which is equal to the number of the lateral grooves 40, can be formed.

Main dead-end sipes 48 can be formed as lateral sipes 42 on each middle land portion 38m. Each main dead-end sipe 48 can have an end in the middle land portion 38m. The main dead-end sipe 48 can extend from this end toward the circumferential groove 24. In the tire 2, a main dead-end sipe 48 connecting the end thereof and the shoulder circumferential groove 24s can be an outer main dead-end sipe 48s. A main dead-end sipe 48 connecting the end thereof and the middle circumferential groove 24m can be an inner main dead-end sipe 48u.

A plurality of outer main dead-end sipes 48s can be formed on each middle land portion 38m. These outer main dead-end sipes 48s can be arranged at intervals in the circumferential direction. A plurality of inner main dead-end sipes 48u can be formed on each middle land portion 38m. These inner main dead-end sipes 48u can be arranged at intervals in the circumferential direction. The pitch between each outer main dead-end sipe 48s and the pitch between each inner main dead-end sipe 48u can be equal to each other.

The direction in which the outer main dead-end sipes 48s are inclined can be the same as the direction in which the inner main dead-end sipes 48u are inclined. The direction in which the inner main dead-end sipes 48u located on the first tread reference end PE1 side are inclined can be the same as the direction in which the inner main dead-end sipe 48u located on the second tread reference end PE2 side are inclined.

In the tire 2, an inclination angle of each inner main dead-end sipe 48u can be larger than an inclination angle of each outer main dead-end sipe 48s. Each outer main dead-end sipe 48s and each inner main dead-end sipe 48u can be arranged such that an inclination angle of a line segment connecting the end of the outer main dead-end sipe 48s and the end of the inner main dead-end sipe 48u is larger than the inclination angle of the outer main dead-end sipe 48s and smaller than the inclination angle of the inner main dead-end sipe 48u. In the tire 2, a combination of an outer main dead-end sipe 48s and an inner main dead-end sipe 48u adjacent to the outer main dead-end sipe 48s may also be referred to as a pair sipe.

A sub dead-end sipe 50 can be formed as a lateral sipe 42 on the middle land portion 38m on the first tread reference end PE1 side. The sub dead-end sipe 50 can have an end in the middle land portion 38m. The sub dead-end sipe 50 can extend from this end toward the shoulder circumferential groove 24s. The direction in which the sub dead-end sipe 50 is inclined can be the same as the direction in which the outer main dead-end sipe 48s is inclined. The sub dead-end sipe 50 can be longer than the outer main dead-end sipe 48s. On this middle land portion 38m, a plurality of sub dead-end sipes 50 can be formed. In the tire 2, the sub dead-end sipes 50 and the outer main dead-end sipes 48s can be arranged alternately in the circumferential direction.

A transverse sipe 52 can be formed as a lateral sipe 42 on the middle land portion 38m on the second tread reference end PE2 side. The transverse sipe 52 can extend between the shoulder circumferential groove 24s and the middle circumferential groove 24m. The direction in which a portion on the shoulder circumferential groove 24s side of the transverse sipe 52 is inclined can be the same as the direction in which the outer main dead-end sipe 48s is inclined. The direction in which a portion on the middle circumferential groove 24m side of the transverse sipe 52 is inclined can be the same as the direction in which the inner main dead-end sipe 48u is inclined. On this middle land portion 38m, a plurality of transverse sipes 52 can be formed. On the middle land portion 38m on the second tread reference end PE2 side, the transverse sipes 52 and pair sipes can be arranged alternately in the circumferential direction.

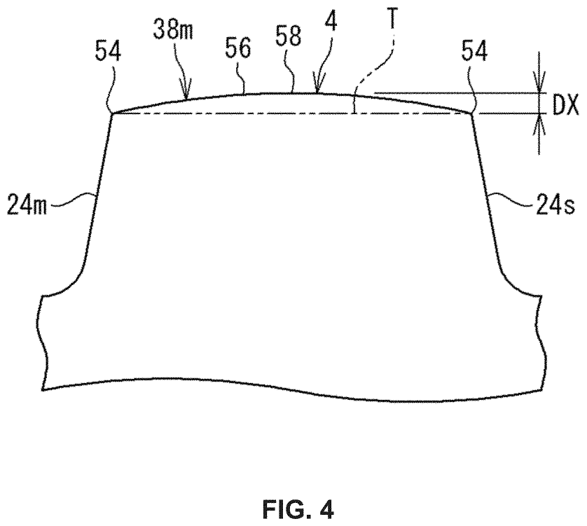

FIG. 4 shows an enlarged cross-sectional view of the middle land portion 38m. FIG. 4 shows a modification of the middle land portion 38m.

In FIG. 4, an alternate long and two short dashes line indicated by reference character T can represent the above-described tread surface T. The tread surface T can pass through right and left edges 54 of the middle land portion 38m. The tread surface T can be a reference surface for the outer surface of the tread 4. An outer surface 56 of the middle land portion 38m shown in FIG. 4 can be located outward of the tread surface T in the radial direction.

As shown in FIG. 4, the outer surface 56 of the middle land portion 38m can have an outwardly curved contour. In the meridian cross-section, the contour of the outer surface 56 of the middle land portion 38m can be represented by an arc that passes through the right and left edges 54 and a top 58.

In the tire 2, since the outer surface 56 of the middle land portion 38m can have an outwardly curved contour, an increase in ground-contact pressure at each edge 54 of the middle land portion 38m can be effectively suppressed. A ground-contact pressure distribution in which the difference between high and low ground-contact pressures is reduced can be obtained, so that the tread 4 can be sufficiently in close contact with a road surface. The coefficient of friction of the tire 2 can be increased, and good braking performance can be achieved. From this viewpoint, in the tire 2, the outer surface 56 of the middle land portion 38m preferably can have an outwardly curved contour.

In FIG. 4, a length indicated by reference character DX can be the maximum height of the outer surface 56 of the middle land portion 38m. The maximum height DX can be represented as the shortest distance from the tread surface T to the top 58.

In the tire 2, from the viewpoint of achieving good braking performance, the maximum height DX of the outer surface 56 of the middle land portion 38m can be preferably not less than 0.05 mm and more preferably not less than 0.08 mm. From the viewpoint of appropriately maintaining the volume of the middle land portion 38m and suppressing an increase in rolling resistance, the maximum height DX can be preferably not greater than 0.15 mm and more preferably not greater than 0.12 mm.

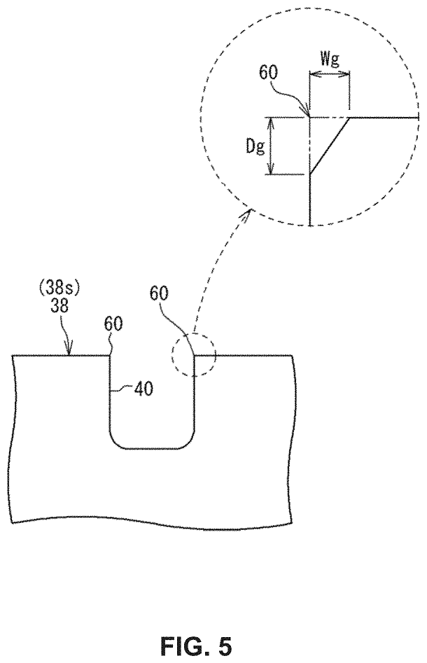

FIG. 5 shows a cross-section of the lateral groove 40 formed on the shoulder land portion 38s. FIG. 5 shows a modification of the lateral groove 40.

As described above, the lateral groove 40 can extend substantially in the axial direction. Edges 60 of the lateral groove 40 can also extend substantially in the axial direction. As shown in FIG. 5, the edge 60 can be chamfered in this lateral groove 40. Accordingly, concentration of strain on the edge 60 of the lateral groove 40 during braking can be suppressed. A ground-contact pressure distribution in which the difference between high and low ground-contact pressures is reduced can be obtained, so that the tread 4 can be sufficiently in close contact with a road surface. The coefficient of friction of the tire 2 can be increased, and good braking performance can be achieved. From this viewpoint, in the tire 2, preferably, the edge 60 of the lateral groove 40 can be chamfered. In this case, from the viewpoint that the tread 4 can be more sufficiently in close contact with a road surface and the coefficient of friction of the tire 2 can be effectively increased, more preferably, both edges 60 of the lateral groove 40 can be chamfered.

FIG. 5 shows an example in which the edge 60 of the lateral groove 40 can be chamfered into a flat surface, but the edge 60 of the lateral groove 40 may be rounded.

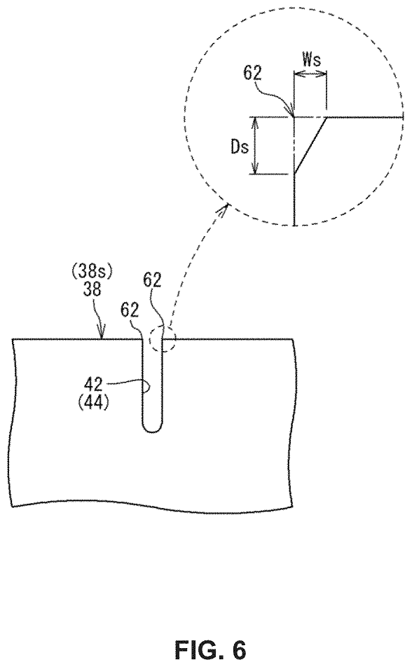

FIG. 6 shows a cross-section of the dead-end sipe 44 formed on the shoulder land portion 38s as an example of the lateral sipe 42 formed on the land portion 38. FIG. 6 shows a modification of the lateral sipe 42.

As described above, the lateral sipe 42 can extend substantially in the axial direction. Edges 62 of the lateral sipe 42 may also extend substantially in the axial direction. As shown in FIG. 6, the edge 62 can be chamfered in this lateral sipe 42. Accordingly, concentration of strain on the edge 62 of the lateral sipe 42 during braking can be suppressed. A ground-contact pressure distribution in which the difference between high and low ground-contact pressures is reduced can be obtained, so that the tread 4 can be sufficiently in close contact with a road surface. The coefficient of friction of the tire 2 can be increased, and good braking performance can be achieved. From this viewpoint, in the tire 2, preferably, the edge 62 of the lateral sipe 42 can be chamfered. In this case, from the viewpoint that the tread 4 can be more sufficiently in close contact with a road surface and the coefficient of friction of the tire 2 can be effectively increased, more preferably, both edges 62 of the lateral sipe 42 can be chamfered.

FIG. 6 shows an example in which the edge 62 of the lateral sipe 42 can be chamfered into a flat surface, but the edge 62 of the lateral sipe 42 may be rounded.

In FIG. 5, a double-headed arrow Dg can indicate the chamfer depth of the edge 60 of the lateral groove 40. A double-headed arrow Wg can indicate the chamfer width of the edge 60. In FIG. 6, a double-headed arrow Ds can indicate the chamfer depth of the edge 62 of the lateral sipe 42. A double-headed arrow Ws can indicate the chamfer width of the edge 62.

In the tire 2, the chamfer depth Dg of the edge 60 of the lateral groove 40 can be preferably larger than the chamfer depth Ds of the edge 62 of the lateral sipe 42. Accordingly, the coefficient of friction of the tire 2 can be effectively increased. From this viewpoint, the chamfer depth Dg of the edge 60 of the lateral groove 40 can be preferably not less than 2.0 mm and not greater than 3.0 mm, and the chamfer depth Ds of the edge 62 of the lateral sipe 42 can be preferably not less than 1.0 mm and not greater than 2.0 mm.

In the tire 2, from the viewpoint of effectively increasing the coefficient of friction of the tire 2, the chamfer width Wg of the edge 60 of the lateral groove 40 can be preferably not less than 1.0 mm and not greater than 2.0 mm. From the same viewpoint, the chamfer width Ws of the edge 62 of the lateral sipe 42 can be preferably not less than 1.0 mm and not greater than 2.0 mm. In this case, the chamfer width Wg and the chamfer width Ws may be the same or different from each other.

In the tire 2, from the viewpoint of effectively increasing the coefficient of friction, preferably, lateral sipes 42 can be formed on each middle land portion 38m so as to extend substantially in the axial direction, and the edges 62 of these lateral sipes 42 can be chamfered. In this case, more preferably, both edges 62 of each lateral sipe 42 can be chamfered. In the tire 2, in the case where the outer surface 56 of the middle land portion 38m can have an outwardly curved contour, when lateral sipes 42 can be formed on the middle land portion 38m so as to extend substantially in the axial direction and the edges 62 of these lateral sipes 42 can be chamfered, the coefficient of friction can be more effectively increased.

In the tire 2, from the viewpoint of effectively increasing the coefficient of friction, preferably, lateral grooves 40 and lateral sipes 42 can be formed on each shoulder land portion 38s so as to extend substantially in the axial direction, and the edges 60 of the lateral grooves 40 and the edges 62 of the lateral sipes 42 can be chamfered. In this case, more preferably, both edges 60 of each lateral groove 40 and both edges 62 of each lateral sipe 42 can be chamfered.

In the case where lateral grooves 40 and lateral sipes 42 can be formed on each shoulder land portion 38s so as to extend substantially in the axial direction and the edges 60 of the lateral grooves 40 and the edges 62 of the lateral sipes 42 can be chamfered, from the viewpoint of more effectively increasing the coefficient of friction of the tire 2, the chamfer depth Dg of the edge 60 of each lateral groove 40 can be preferably larger than the chamfer depth Ds of the edge 62 of each lateral sipe 42.

As described above, according to the present disclosure, the tire 2 that can achieve improvement of braking performance without a significant increase in rolling resistance can be obtained.

### EXAMPLES

Hereinafter, the present disclosure will be described in further detail by means of examples, etc., but the present disclosure is not limited to these examples.

### Example 1

A pneumatic tire for a passenger car (tire size=205/60R16) having the basic structure shown in FIG. 1 and having specifications shown in Table 1 below was obtained.

The ratio (R1/R2) of the radius R1 of the first arc included in the contour of each side surface to the radius R2 of the second arc included therein was 86%. The radius R1 was 55 mm.

The ratio (A/H) of the height A of the apex to the cross-sectional height H was 10%. The carcass was composed of one carcass ply, and the ratio (F/W) of the height F of the turned-up portion to the maximum width height W was 58%.

### Comparative Example 1

A tire of Comparative Example 1 is a conventional tire. In Comparative Example 1, the ratio (R1/R2) of the radius R1 of the first arc included in the contour of each side surface to the radius R2 of the second arc included therein was 100%. The radius R1 was 70 mm.

The ratio (A/H) of the height A of the apex to the cross-sectional height H was 20%. The carcass was composed of two carcass plies. Although not shown, the two carcass plies were turned up around each bead from the inner side toward the outer side in the axial direction. The ratio of the height of the first turned-up portion located on the outer side in the axial direction to the maximum width height was 65%. The ratio of the height of the second turned-up portion located inward of the first turned-up portion in the axial direction to the maximum width height was 20%.

### Examples 2 to 7 and Comparative Examples 2 to 4

Tires of Examples 2 to 7 and Comparative Examples 2 to 4 were obtained in the same manner as Example 1, except that the radius R1 of the first arc and the ratio (R1/R2) were set as shown in Tables 1 and 2 below while adjusting the radius R2 of the second arc.

### Examples 8 and 9

Tires of Examples 8 and 9 were obtained in the same manner as Example 1, except that the ratio (A/H) was set as shown in Table 3 below.

### Examples 10 and 11

Tires of Examples 10 and 11 were obtained in the same manner as Example 1, except that the ratio (F/W) was set as shown in Table 3 below.

### Example 12

A tire of Example 12 was obtained in the same manner as Example 1, except that the middle land portion was changed to a middle land portion having the configuration shown in FIG. 4. The maximum height DX was set to 0.10 mm.

### Example 13

A tire of Example 13 was obtained in the same manner as Example 12, except that both edges of each of the lateral grooves and the lateral sipes formed on the land portions were chamfered. The chamfer width Wg of each lateral groove was 1.5 mm, and the chamfer depth Dg of each lateral groove was 2.5 mm. The chamfer width Ws of each lateral sipe was 1.5 mm, and the chamfer depth Ds of each lateral sipe was 1.5 mm. The fact of being chamfered is represented as “Y” in the cell for chamfer in Table 3 below. “N” in cells for chamfer in each table represents that no chamfer is provided.

### [Braking Performance]

Test tires were fitted to rims (size=16×6.5) and inflated with air to adjust the internal pressures of the tires to 250 kPa. The tires were mounted to a test vehicle (passenger car), and the test vehicle was driven on a test course for braking performance evaluation. A braking distance from a speed of 110 km/h was measured. The results are shown as indexes in Tables 1 to 3 below. The higher the value is, the shorter the braking distance is and the better the braking performance of the tire is.

### [Rolling Resistance Coefficient (RRC)]

Using a rolling resistance testing machine, a rolling resistance coefficient (RRC) was measured when a test tire ran on a drum at a speed of 80 km/h under the following conditions. The results are shown as indexes in Tables 1 to 3 below. The higher the value is, the lower the rolling resistance of the tire is. In this evaluation, if the index is 95 or higher, it is acceptable as it is determined that there is no significant increase in rolling resistance.
Rim: 16×6.5 J
Internal pressure: 250 kPa
Vertical load: 5.43 kN

### [Level of Achievement]

The total of the indexes obtained in the evaluation of braking performance and rolling resistance was calculated. The results are shown in the cells for “Level of achievement” in Tables 1 to 3 below. The higher the value is, the better the result is.

### [Durability]

A test tire was fitted to a rim (size=16×6.5) and inflated with air to adjust the internal pressure of the tire to 250 kPa. A durability test was carried out using a drum tester by a step speed method according to the load/speed performance test specified by ECE30. The running distance until the tire became broken was measured. The results are shown as indexes in Tables 1 to 3 below. The higher the value is, the better the durability of the tire is. In this evaluation, if the index is 95 or higher, it is acceptable as it is determined that there is no significant decrease in durability.

TABLE 1

| | | Comparative | | | | | |
|---|---|---|---|---|---|---|---|
| | | Example 1 | Example 2 | Example 3 | Example 4 | Example 5 | Example 1 |
| R1/R2 [%] | | 100 | 70 | 75 | 80 | 86 | 86 |
| R1 [mm] | | 70 | 53 | 53 | 60 | 49 | 55 |
| A/H [%] | | 20 | 10 | 10 | 10 | 10 | 10 |
| Number of plies | | 2 | 1 | 1 | 1 | 1 | 1 |
| F/W [%] | | — | 58 | 58 | 58 | 58 | 58 |
| DX [mm] | | — | — | — | — | — | — |
| Chamfer | Lateral | N | N | N | N | N | N |
| | groove | | | | | | |
| | Sipe | N | N | N | N | N | N |

| | | | | | | |
|---|---|---|---|---|---|---|
| Braking | 85 | 105 | 108 | 110 | 105 | 110 |
| performance | | | | | | |
| RRC | 93 | 100 | 100 | 100 | 100 | 100 |
| Level of | 178 | 205 | 208 | 210 | 205 | 210 |
| achievement | | | | | | |
| Durability | 100 | 95 | 100 | 100 | 100 | 100 |

TABLE 2

| | | | | Comparative | Comparative | Comparative |
|---|---|---|---|---|---|---|
| | | Example 6 | Example 7 | Example 2 | Example 3 | Example 4 |
| R1/R2 [%] | | 86 | 86 | 97 | 100 | 140 |
| R1 [mm] | | 65 | 70 | 60 | 70 | 70 |
| A/H [%] | | 10 | 10 | 10 | 10 | 10 |
| Number of plies | | 1 | 1 | 1 | 1 | 1 |
| F/W [%] | | 58 | 58 | 58 | 58 | 58 |
| DX [mm] | | — | — | — | — | — |
| Chamfer | Lateral | N | N | N | N | N |
| | groove | | | | | |
| | Sipe | N | N | N | N | N |

| | | | | | |
|---|---|---|---|---|---|
| Braking | 107 | 105 | 102 | 100 | 80 |
| performance | | | | | |
| RRC | 100 | 100 | 100 | 100 | 105 |
| Level of | 207 | 205 | 202 | 200 | 185 |
| achievement | | | | | |
| Durability | 100 | 100 | 100 | 100 | 100 |

TABLE 3

| | | Example 8 | Example 9 | Example 10 | Example 11 | Example 12 | Example 13 |
|---|---|---|---|---|---|---|---|
| R1/R2 [%] | | 86 | 86 | 86 | 86 | 86 | 86 |
| R1 [mm] | | 55 | 55 | 55 | 55 | 55 | 55 |
| A/H [%] | | 5 | 15 | 10 | 10 | 10 | 10 |
| Number of plies | | 1 | 1 | 1 | 1 | 1 | 1 |
| F/W [%] | | 58 | 58 | 50 | 65 | 58 | 58 |
| DX [mm] | | — | — | — | — | 0.10 | 0.10 |
| Chamfer | Lateral | N | N | N | N | N | Y |
| | groove | | | | | | |
| | Sipe | N | N | N | N | N | Y |

| | | | | | | |
|---|---|---|---|---|---|---|
| Braking | 110 | 108 | 110 | 108 | 120 | 140 |
| performance | | | | | | |
| RRC | 100 | 95 | 100 | 100 | 100 | 100 |
| Level of | 210 | 203 | 210 | 208 | 220 | 240 |
| achievement | | | | | | |
| Durability | 96 | 103 | 98 | 100 | 100 | 100 |

As shown in Tables 1 to 3, it is confirmed that, in each Example, it is possible to achieve improvement of braking performance without a significant increase in rolling resistance. From the evaluation results, advantages of the present disclosure are clear.

The above-described technology capable of achieving improvement of braking performance without a significant increase in rolling resistance can also be applied to various tires.

Preferably, in the tire, the radius of the first arc can be not less than 50 mm and not greater than 65 mm.

Preferably, in the tire, the carcass can include a carcass ply. The carcass ply can include a ply body extending between one bead and the other bead, and a pair of turned-up portions connected to the ply body and turned up around the beads from an inner side toward an outer side in an axial direction. A ratio of a distance in the radial direction from a bead base line to an end of the turned-up portion to a distance in the radial direction from the bead base line to the maximum width position may be not less than 48% and not greater than 68%.

Preferably, in the tire, a plurality of circumferential grooves can be formed on the tread, whereby a plurality of land portions can be formed, and, among the plurality of land portions, the land portion located on each outer side in the axial direction can be a shoulder land portion, and the land portion located inward of the shoulder land portion can be a middle land portion. An outer surface of the middle land portion can have an outwardly curved contour. A maximum height of the outer surface may be not less than 0.05 mm and not greater than 0.15 mm.

Preferably, in the tire, a lateral sipe can be formed on the middle land portion so as to extend substantially in the axial direction, and an edge of the lateral sipe can be chamfered.

Preferably, in the tire, a lateral groove and a lateral sipe can be formed on the shoulder land portion so as to extend substantially in the axial direction, and edges of the lateral groove and the lateral sipe can be chamfered.

Preferably, a ratio of a first distance in the radial direction from the maximum width position to an endpoint of the first arc to a second distance in the radial direction from the maximum width position to a flange reference position is not less than 0.70, and the flange reference position is an intersection between the side surface and a straight line in the radial direction that passes through an outer end portion of a flange of the tire.

Preferably, the ratio of the first distance to the second distance is 1.0.

Preferably, a ratio of a first distance in the radial direction from the maximum width position to an endpoint of the second arc to a second distance in the radial direction from the maximum width position to a buttress reference position is not less than 0.70.

Preferably, the ratio of the first distance to the second distance is 1.0.

Preferably, an angle between a first straight line passing through a tip of the apex and a width center of a surface of the apex touching the core and a second straight line that passing through the tip of the apex and an end of a turned-up portion of the carcass is 35 degrees to 50 degrees inclusive.

Preferably, the tire can further comprise: a lateral groove; and a lateral sipe, wherein edges of the lateral groove and the lateral sipe are chamfered, and a first chamfer depth of the lateral groove is greater than a second chamfer depth of the lateral sipe.

Preferably, the first chamfer depth of the lateral groove is not less than 2.0 mm and not greater than 3.0 mm, and the second chamfer depth of the lateral sipe is not less than 1.0 mm and not greater than 2.0 mm.

Preferably, a first chamfer width of the lateral groove is not less than 1.0 mm and not greater than 2.0 mm, and a second chamfer width of the lateral sipe is not less than 1.0 mm and not greater than 2.0 mm.

Preferably, a plurality of middle land portions are between opposing shoulder land portions, and the middle land portion is without any lateral grooves.

Preferably, a plurality of circumferential grooves are formed on the tread, whereby a plurality of land portions are formed, among the plurality of land portions, the land portion located on each outer side in the axial direction is a shoulder land portion, and each of the shoulder land portions includes a plurality of lateral grooves and a first plurality of lateral sipes that alternate in a circumferential direction of the tire.

Preferably, for at least one of the shoulder land portions a second plurality of lateral sipes extend from ends of respective ones of the lateral grooves.

According to the present disclosure, a tire that can achieve improvement of braking performance without a significant increase in rolling resistance can be obtained.

What is claimed is:

1. A tire comprising:
a tread to come into contact with a road surface;
a pair of sidewalls each connected to an end of the tread and located inward of the tread in a radial direction;
a pair of beads each located inward of a corresponding one of the sidewalls in the radial direction, and
a carcass located inward of the tread and the pair of sidewalls, wherein
each bead includes a core and an apex located outward of the core in the radial direction,
a ratio of a height of the apex to a cross-sectional height of the tire is not less than 5% and not greater than 15%,
in a meridian cross-section in a state where the tire is fitted on a normal rim, an internal pressure of the tire is adjusted to 250 kPa, and no load is applied to the tire, a contour of each side surface including a maximum width position includes two arcs tangent to each other at the maximum width position,
of the two arcs, a first arc is located inward of the maximum width position in the radial direction, and a second arc is located outward of the maximum width position in the radial direction, and
a ratio of a first radius of the first arc to a second radius of the second arc is not less than 70% and not greater than 91%.

2. The tire according to claim 1, wherein the first radius of the first arc is not less than 50 mm and not greater than 65 mm.

3. The tire according to claim 1, wherein
the carcass includes a carcass ply,
the carcass ply includes a ply body extending between one bead and the other bead of the pair of beads, and a pair of turned-up portions connected to the ply body and turned up around the beads from an inner side toward an outer side in an axial direction, and
a ratio of a first distance in the radial direction from a bead base line to an end of the turned-up portion to a second distance in the radial direction from the bead base line to the maximum width position is not less than 48% and not greater than 68%.

4. The tire according to claim 2, wherein
the carcass includes a carcass ply,
the carcass ply includes a ply body extending between one bead and the other bead of the pair of beads, and a pair of turned-up portions connected to the ply body and turned up around the beads from an inner side toward an outer side in an axial direction, and
a ratio of a first distance in the radial direction from a bead base line to an end of the turned-up portion to a second distance in the radial direction from the bead base line to the maximum width position is not less than 48% and not greater than 68%.

5. The tire according to claim 1, wherein
a plurality of circumferential grooves are formed on the tread, whereby a plurality of land portions are formed,
among the plurality of land portions, the land portion located on each outer side in the axial direction is a shoulder land portion, and the land portion located inward of the shoulder land portion is a middle land portion,
an outer surface of the middle land portion has an outwardly curved contour, and
a maximum height of the outer surface is not less than 0.05 mm and not greater than 0.15 mm.

6. The tire according to claim 3, wherein
a plurality of circumferential grooves are formed on the tread, whereby a plurality of land portions are formed,
among the plurality of land portions, the land portion located on each outer side in the axial direction is a shoulder land portion, and the land portion located inward of the shoulder land portion is a middle land portion,
an outer surface of the middle land portion has an outwardly curved contour, and
a maximum height of the outer surface is not less than 0.05 mm and not greater than 0.15 mm.

7. The tire according to claim 4, wherein
a plurality of circumferential grooves are formed on the tread, whereby a plurality of land portions are formed,
among the plurality of land portions, the land portion located on each outer side in the axial direction is a shoulder land portion, and the land portion located inward of the shoulder land portion is a middle land portion,
an outer surface of the middle land portion has an outwardly curved contour, and
a maximum height of the outer surface is not less than 0.05 mm and not greater than 0.15 mm.

8. The tire according to claim 5, wherein
a lateral sipe is formed on the middle land portion so as to extend substantially in the axial direction, and
an edge of the lateral sipe is chamfered.

9. The tire according to claim 6, wherein
a lateral sipe is formed on the middle land portion so as to extend substantially in the axial direction, and
an edge of the lateral sipe is chamfered.

10. The tire according to claim 5, wherein
a lateral groove and a lateral sipe are formed on the shoulder land portion so as to extend substantially in the axial direction, and
edges of the lateral groove and the lateral sipe are chamfered.

11. The tire according to claim 6, wherein
a lateral groove and a lateral sipe are formed on the shoulder land portion so as to extend substantially in the axial direction, and
edges of the lateral groove and the lateral sipe are chamfered.

12. The tire according to claim 1, wherein
a ratio of a first distance in the radial direction from the maximum width position to an endpoint of the first arc to a second distance in the radial direction from the maximum width position to a flange reference position is not less than 0.70, and
the flange reference position is an intersection between the side surface and a straight line in the radial direction that passes through an outer end portion of a flange of the tire.

13. The tire according to claim 6, wherein
a ratio of a first distance in the radial direction from the maximum width position to an endpoint of the first arc to a second distance in the radial direction from the maximum width position to a flange reference position is not less than 0.70, and
the flange reference position is an intersection between the side surface and a straight line in the radial direction that passes through an outer end portion of a flange of the tire.

14. The tire according to claim 1, wherein a ratio of a first distance in the radial direction from the maximum width position to an endpoint of the second arc to a second distance in the radial direction from the maximum width position to a buttress reference position is not less than 0.70.

15. The tire according to claim 6, wherein a ratio of a first distance in the radial direction from the maximum width position to an endpoint of the second arc to a second distance in the radial direction from the maximum width position to a buttress reference position is not less than 0.70.

16. The tire according to claim 1, wherein an angle between a first straight line passing through a tip of the apex and a width center of a surface of the apex touching the core and a second straight line that passing through the tip of the apex and an end of a turned-up portion of the carcass is 35 degrees to 50 degrees inclusive.

17. The tire according to claim 6, wherein an angle between a first straight line passing through a tip of the apex and a width center of a surface of the apex touching the core and a second straight line that passing through the tip of the apex and an end of a turned-up portion of the carcass is 35 degrees to 50 degrees inclusive.

18. The tire according to claim 1, further comprising:
a lateral groove; and
a lateral sipe, wherein
edges of the lateral groove and the lateral sipe are chamfered,
a first chamfer depth of the lateral groove is greater than a second chamfer depth of the lateral sipe,
the first chamfer depth of the lateral groove is not less than 2.0 mm and not greater than 3.0 mm,
the second chamfer depth of the lateral sipe is not less than 1.0 mm and not greater than 2.0 mm,
a first chamfer width of the lateral groove is not less than 1.0 mm and not greater than 2.0 mm, and
a second chamfer width of the lateral sipe is not less than 1.0 mm and not greater than 2.0 mm.

19. The tire according to claim 6, further comprising:
a lateral groove; and
a lateral sipe, wherein
edges of the lateral groove and the lateral sipe are chamfered,
a first chamfer depth of the lateral groove is greater than a second chamfer depth of the lateral sipe,
the first chamfer depth of the lateral groove is not less than 2.0 mm and not greater than 3.0 mm,
the second chamfer depth of the lateral sipe is not less than 1.0 mm and not greater than 2.0 mm,
a first chamfer width of the lateral groove is not less than 1.0 mm and not greater than 2.0 mm, and
a second chamfer width of the lateral sipe is not less than 1.0 mm and not greater than 2.0 mm.

20. The tire according to claim 1, wherein
a plurality of middle land portions are between opposing shoulder land portions, and
the middle land portion is without any lateral grooves.

21. The tire according to claim 1, wherein
a plurality of circumferential grooves are formed on the tread, whereby a plurality of land portions are formed,
among the plurality of land portions, the land portion located on each outer side in the axial direction is a shoulder land portion, and
each of the shoulder land portions includes a plurality of lateral grooves and a first plurality of lateral sipes that alternate in a circumferential direction of the tire.

22. The tire according to claim 21, wherein
for at least one of the shoulder land portions a second plurality of lateral sipes extend from ends of respective ones of the lateral grooves.
